(19) United States
(12) Patent Application Publication
(10) Pub. No.: US 2026/0309245 A1
(43) Pub. Date: Oct. 8, 2026

(54) PROTECTIVE ENCLOSURE FOR SECURING VALVES

(71) Applicant: Black Gold Vault Co., Midland, TX (US)

(72) Inventors: Benjamin K. Kimbrough, Midland, TX (US); Layton Gill, Midland, TX (US)

(21) Appl. No.: 19/197,516

(22) Filed: May 2, 2025

Related U.S. Application Data
(60) Provisional application No. 63/784,719, filed on Apr. 7, 2025.

(51) Int. Cl. F16K 17/02; B23K 31/02

(52) U.S. Cl. CPC F16K 17/02; B23K 31/02

(57) ABSTRACT

A protective enclosure for a valve includes a first open box structure having a first semicircular opening at an end, and a second open box structure having a second semicircular opening and an aperture. The second semicircular opening is disposed at an end of the second open box structure, and the aperture is disposed on a top surface of the second open box structure. A lock guard is provided on the top surface of the second open box structure, disposed over the aperture. An external lip is positioned to cover a seam between the first open box structure and the second open box structure when joined together.

### CROSS-REFERENCE TO RELATED APPLICATIONS

This application claims the benefit of U.S. Provisional Application No. 63/784,719, filed on Apr. 7, 2025, which application is hereby incorporated herein by reference.

### TECHNICAL FIELD

This disclosure relates generally to security devices for fluid systems, and, in particular embodiments, to protective enclosures for securing valves.

### BACKGROUND

Valves are mechanical devices used to control the flow of liquids or gases in various systems. They can be found in numerous applications across industries such as oil and gas, water treatment, and manufacturing. Valves typically consist of a body, bonnet, stem, and actuator, with different types including gate valves, globe valves, and ball valves.

Pipes are cylindrical structures used to transport liquids or gases from one location to another. They can be made from various materials such as steel, copper, or plastic, depending on the specific application and requirements. Pipe systems are utilized in diverse settings, ranging from residential plumbing to large-scale industrial operations.

Industrial fluid systems often incorporate both valves and pipes to manage the flow of liquids or gases. These systems may be designed for purposes such as distribution, processing, or storage of fluids. The proper functioning of valves and pipes is integral to maintaining efficiency and safety in many industrial processes.

### SUMMARY

In an embodiment, a protective enclosure includes: a first open box structure having a first semicircular opening at an end of the first open box structure; a second open box structure having a second semicircular opening and an aperture, the second semicircular opening disposed at an end of the second open box structure, the aperture disposed on a top surface of the second open box structure; a lock guard on the top surface of the second open box structure, the lock guard disposed over the aperture; and an external lip positioned to cover a seam between the first open box structure and the second open box structure when the first open box structure and the second open box structure are joined together. In some embodiments of the protective enclosure, the seam is connected to a pipe opening formed by the first semicircular opening merging with the second semicircular opening when the first open box structure and the second open box structure are joined together. In some embodiments of the protective enclosure, the external lip is affixed to a sidewall of the second open box structure and overlaps a sidewall of the first open box structure when the first open box structure and the second open box structure are joined together. In some embodiments of the protective enclosure, the external lip extends up the sidewall of the second open box structure further than the external lip extends down the sidewall of the first open box structure. In some embodiments of the protective enclosure, the external lip is affixed to a sidewall of the first open box structure and overlaps a sidewall of the second open box structure when the first open box structure and the second open box structure are joined together. In some embodiments of the protective enclosure, the external lip extends down the sidewall of the first open box structure further than the external lip extends up the sidewall of the second open box structure. In some embodiments of the protective enclosure, the lock guard is offset from a center of the second open box structure. In some embodiments of the protective enclosure, the aperture is aligned with the center of the second open box structure. In some embodiments of the protective enclosure, the aperture extends in a direction that forms a right angle with a sidewall of the second open box structure. In some embodiments of the protective enclosure, the aperture extends in a direction that forms an oblique angle with a sidewall of the second open box structure. In some embodiments of the protective enclosure, a thickness of the external lip is different than a thickness of the first open box structure and the second open box structure. In some embodiments, the protective enclosure further includes: a clamping assembly including a first clamp and mounting nuts, the first clamp affixed to the first open box structure and around the first semicircular opening, the mounting nuts affixed to the first clamp. In some embodiments of the protective enclosure, the clamping assembly further includes a second clamp, the second clamp including a locking tab that extends through the aperture when the first open box structure and the second open box structure are joined together.

In an embodiment, a method includes: fabricating a first open box structure from a first metal sheet, the first open box structure having a first semicircular opening at an end of the first open box structure; fabricating a second open box structure from a second metal sheet, the second open box structure having a second semicircular opening at an end of the second open box structure; fabricating an external lip from a third metal sheet; and welding the external lip to a sidewall of the second open box structure, the external lip positioned to cover a seam between the first open box structure and the second open box structure when the first open box structure and the second open box structure are joined together. In some embodiments of the method, the external lip covers a greater portion of the sidewall of the second open box structure than a sidewall of the first open box structure. In some embodiments of the method, the first metal sheet and the second metal sheet are thicker than the third metal sheet. In some embodiments of the method, the first metal sheet, the second metal sheet, and the third metal sheet are each formed of A36 steel. In some embodiments, the method further includes: welding a clamp to the first open box structure and around the first semicircular opening. In some embodiments of the method, the second open box structure has an aperture in a top surface of the second open box structure, and the method further includes: welding a lock guard to the top surface of the second open box structure and over the aperture.

In an embodiment, a method includes: positioning a first open box structure beneath a pipe and a valve, the first open box structure having a first semicircular opening at an end of the first open box structure, the first semicircular opening being aligned with the pipe; securing the first open box structure to the pipe by fastening a clamping assembly to the pipe; positioning a second open box structure over the first open box structure, the second open box structure having a second semicircular opening at an end of the second open box structure, the second semicircular opening being aligned with the pipe; engaging an external lip over a seam between the first open box structure and the second open box structure; inserting a locking tab of the clamping assembly through an aperture in the second open box structure; and installing a locking mechanism through a lock opening in the locking tab. In some embodiments of the method, the clamping assembly includes a first clamp and a second clamp, and fastening the clamping assembly to the pipe includes fastening the first clamp to the second clamp and around the pipe. In some embodiments of the method, the locking mechanism includes a padlock and installing the locking mechanism includes inserting a shackle of the padlock through the lock opening in the locking tab. In some embodiments of the method, the locking mechanism is installed under a lock guard that is attached to the second open box structure. In some embodiments of the method, the first open box structure and the second open box structure form a box-shaped structure that completely surrounds the valve on six sides. In some embodiments of the method, the external lip covers a greater portion of a sidewall of the second open box structure than a sidewall of the first open box structure.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 illustrates a schematic view of a protective system for securing a valve, according to some embodiments;

FIG. 2 illustrates an isometric view of a protective system for securing a valve, according to some embodiments;

FIGS. 3A-3E illustrate various views of a protective enclosure, according to some embodiments;

FIG. 4 illustrates an exploded isometric view of a protective enclosure, according to some embodiments;

FIG. 5 illustrates clamping assemblies for a protective enclosure, according to some embodiments;

FIG. 6 illustrates an exploded isometric view of a protective enclosure, according to some embodiments;

FIG. 7 illustrates a cross-sectional view of a protective enclosure, according to some other embodiments;

FIG. 8 illustrates clamping assemblies for a protective enclosure, according to some other embodiments;

FIG. 9 illustrates clamping assemblies for a protective enclosure, according to some other embodiments;

FIG. 10 illustrates a flowchart of a method for installing a protective enclosure, according to some embodiments; and

FIG. 11 illustrates a flowchart of a method for manufacturing a protective enclosure, according to some embodiments.

### DETAILED DESCRIPTION

The following description sets forth exemplary aspects of this disclosure. It should be recognized, however, that such description is not intended as a limitation on the scope of this disclosure. Rather, the description also encompasses combinations and modifications to those exemplary aspects described herein.

Valves play a vital role in controlling the flow of fluids in many industries, such as oil, gas, water, and the like. However, these valves are often left exposed and vulnerable to tampering, theft, or unauthorized operation. This can lead to problems like product loss, environmental damage, or safety hazards. Current methods of protecting valves, such as simple locks or chains, often fall short in providing adequate security, especially in remote locations where valves may be unattended, offering intruders opportunities to defeat basic safeguards.

This disclosure describes a protective enclosure for securing valves against unauthorized access and tampering. The protective enclosure is a durable metal enclosure that completely surrounds a valve on six sides, with openings that allow a pipe to pass through while keeping the valve itself inaccessible. The protective enclosure is secured with locking mechanisms (such as padlocks), and has multiple secure points which make the protective enclosure difficult to breach, even with tools. At the same time, the protective enclosure allows quick and easy access for authorized personnel who need to operate or maintain the valve. By providing a formidable physical barrier and visual deterrent, the protective enclosure can significantly enhance the security and reliability of industrial fluid systems, potentially saving organizations from product losses and safety incidents.

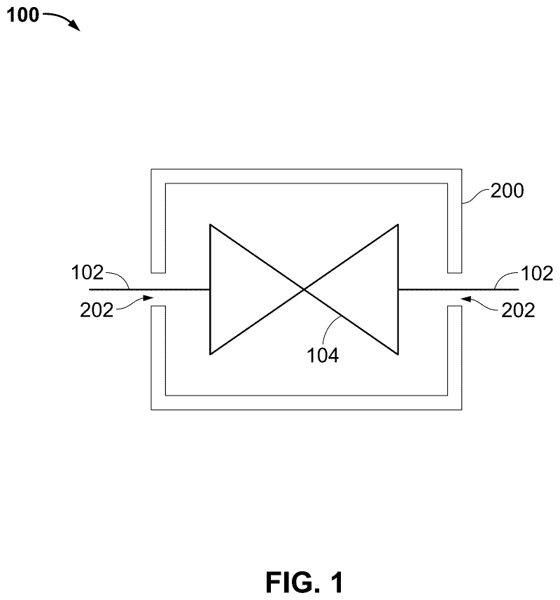

FIG. 1 illustrates a schematic view of a protective system 100 for securing a valve, according to some embodiments. The protective system 100 includes a pipe 102, a valve 104 affixed to the pipe 102, and a protective enclosure 200 around the valve 104. The pipe 102 extends lengthwise (e.g., horizontally in the figure) through pipe openings 202 at opposite ends of the protective enclosure 200. The valve 104 may be positioned within the protective enclosure 200 between the pipe openings 202. The protective enclosure 200 surrounds and encloses the valve 104, providing a physical barrier around the valve 104.

The pipe openings 202 may be sized to accommodate the pipe 102 passing through the protective enclosure 200 while maintaining the security of the enclosed valve 104. In some cases, the protective enclosure 200 may be sized to fit valves of different dimensions. For example, the protective enclosure 200 may be sized to accommodate 2-inch, 3-inch, or 4-inch valves.

The protective enclosure 200 may serve as a physical barrier to prevent unauthorized access to the valve 104. By enclosing the valve 104 within the protective enclosure 200, the system may deter tampering, theft, or unauthorized operation of the valve 104 while still allowing the pipe 102 to pass through the assembly.

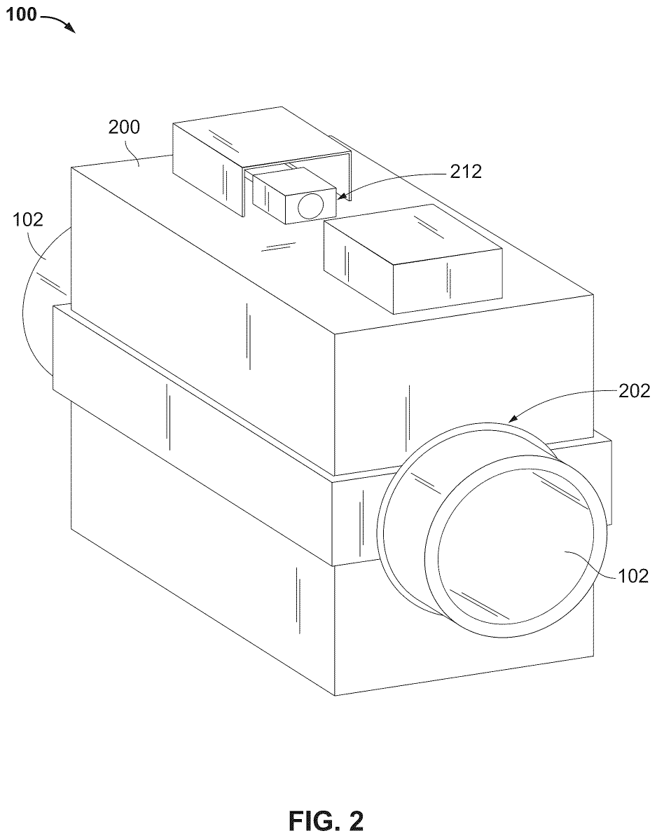

FIG. 2 illustrates an isometric view of a protective system 100 for securing a valve, according to some embodiments. Specifically, the protective system 100 of FIG. 1 is shown in more detail. The protective enclosure 200 secures the valve 104 (see FIG. 1) along the pipe 102, which passes through the pipe openings 202 of the protective enclosure 200. The pipe openings 202 may be circle-shaped openings. The protective enclosure 200 is a box-shaped structure that provides protection for a valve enclosed therein. The protective enclosure 200 includes multiple security features that make tampering difficult, as subsequently described in greater detail.

One or more locking mechanisms 212 may be used to securely lock the protective enclosure 200, preventing unauthorized access to the valve inside while allowing the pipe 102 to remain functional. The locking mechanisms 212 may be padlocks, combination locks, key-operated locks, electronic locks, cable locks, or any other suitable mechanical or electrical mechanism. An authorized operator may access the valve 104 by unlocking the locking mechanisms 212, which allows the protective enclosure 200 to be removed from the pipe 102.

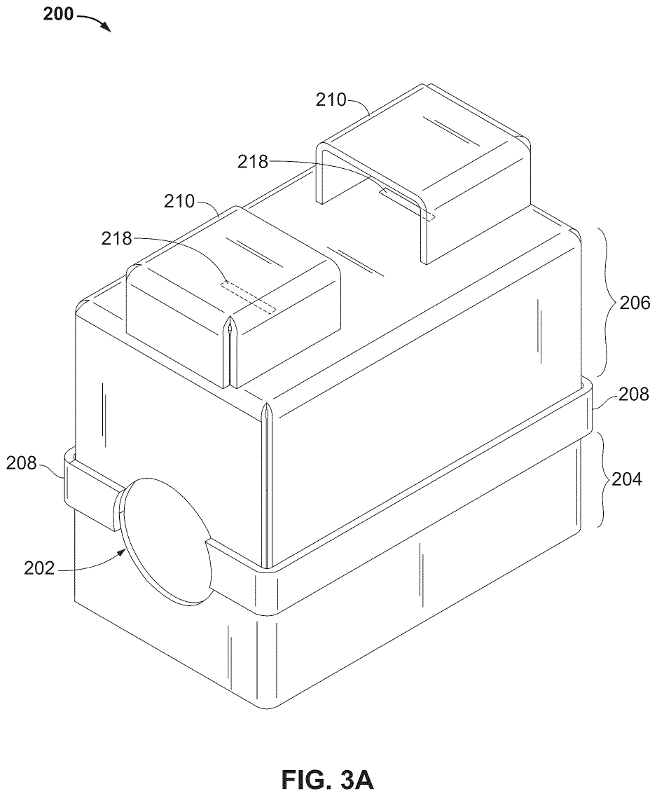

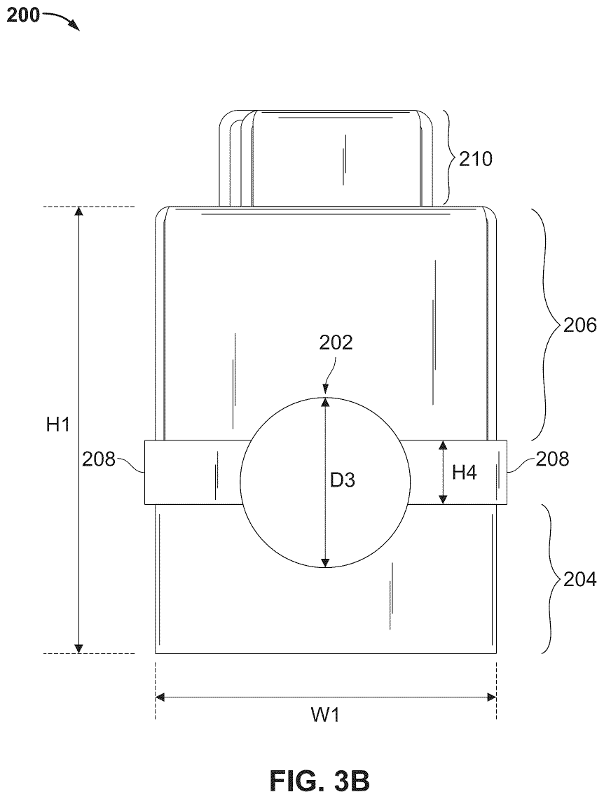

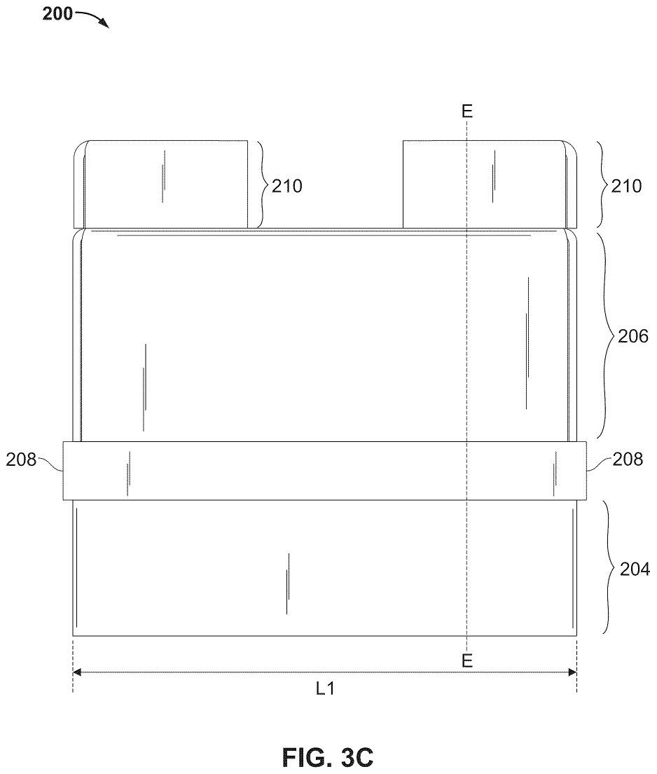

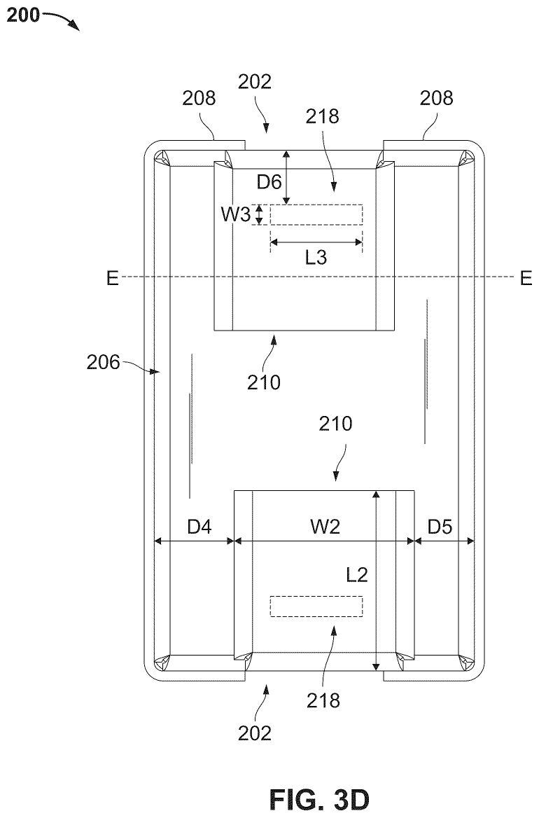

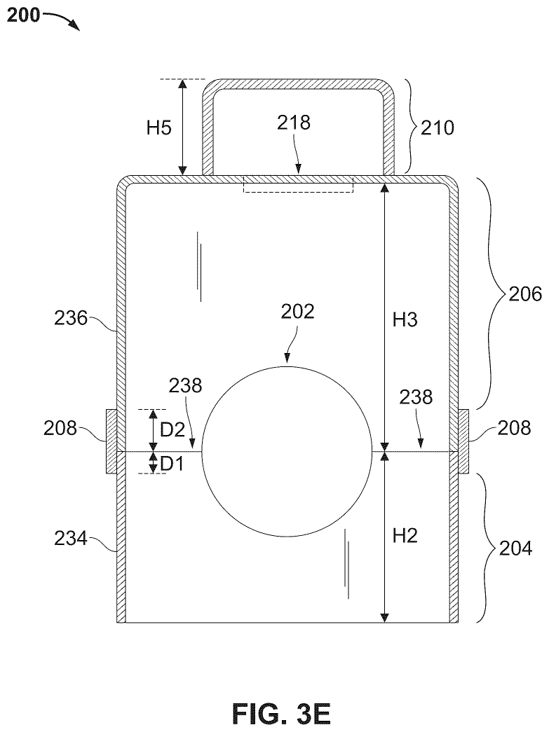

FIGS. 3A-3E illustrate various views of a protective enclosure 200, according to some embodiments. Specifically, the protective enclosure 200 of FIGS. 1-2 is shown in more detail.

Referring to FIG. 3A, an isometric view of the protective enclosure 200 is shown. The protective enclosure 200 has an elongated arrangement with the pipe openings 202 centered on opposing ends of the protective enclosure 200. Thus, the protective enclosure 200 may extend lengthwise along a pipe passing through the pipe openings 202.

The protective enclosure 200 includes a first portion 204 and a second portion 206 that assemble together to form a box-shaped structure. The first portion 204 is an open box structure and will be the lower portion of the box-shaped structure. The second portion 206 is an open box structure and will be the upper portion of the box-shaped structure. The open sides of the two open box structures will be joined together to form the box-shaped structure. When assembled together, the first portion 204 and the second portion 206, together, completely surround (on six sides) a valve while allowing a pipe to pass through the pipe openings 202. The first portion 204 and the second portion 206 may be taken apart to allow authorized access to the enclosed valve when necessary.

The first portion 204 and the second portion 206 have multiple seams where the portions meet when joined together. Specifically, there may be two seams extend lengthwise down the sides of the protective enclosure 200. There may be one seam on each side of the pipe openings 202.

The protective enclosure 200 also includes external lips 208 that extend along the seams where the first portion 204 and the second portion 206 meet when joined together. Specifically, each external lip 208 is a rectangular structure that extends continuously along a sidewall of the protective enclosure 200 as well as along each end of the protective enclosure 200. The external lips 208 overhang both the first portion 204 and the second portion 206, and extend along the sides of the protective enclosure 200. Thus, the external lips 208 are disposed around the pipe openings 202. This arrangement of the external lips 208 may help prevent unauthorized access to the interior of the protective enclosure 200 by covering the seams between the first portion 204 and the second portion 206. The external lips 208 prevent unauthorized access to the seams where the first portion 204 and the second portion 206 meet. The external lips 208 effectively block insertion of prying tools such as crowbars that might otherwise be used to force the two portions apart.

As subsequently described in greater detail, the external lips 208 may be attached to the first portion 204 or the second portion 206. Specifically, the external lips 208 are permanently affixed to one portion and extend downward/upwards to overlap the other portion when the first portion 204 and the second portion 206 are assembled together. The external lips 208 may be affixed to only one of the two portions, allowing the portions to be separated for authorized access while providing protection against unauthorized entry when assembled.

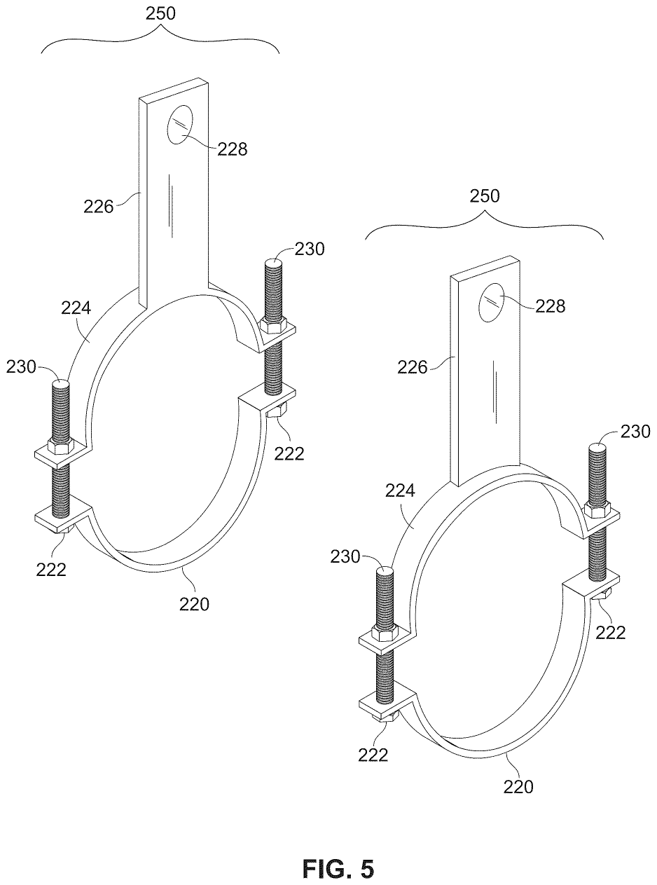

The top surface of the second portion 206 may include apertures 218. As subsequently described in greater detail, the protective enclosure 200 includes clamping assemblies (see FIG. 5). The apertures 218 may receive locking tabs of the clamping assemble when the protective enclosure 200 is assembled around a pipe. Specifically, during assembly, the locking tabs may extend through the apertures 218 and locking mechanisms may be fitted through the locking tabs, thus preventing the clamps from falling back through the apertures 218. This secures the first portion 204 to the second portion 206.

The protective enclosure 200 also includes lock guards 210 on the top surface of the second portion 206. The lock guards 210 are positioned over the apertures 218 and may be used to cover and protect locking mechanisms when the protective enclosure 200 is assembled. This prevents tampering with the locking mechanisms, such as by preventing the insertion of prying tools into the locking mechanisms or by preventing cutting of the locking mechanisms with bolt cutters, saws, or the like. Thus, the locking mechanisms may be secured beneath the lock guards to prevent unauthorized access to the contents of the protective enclosure 200.

The protective enclosure 200 may be formed of durable metal materials such as steel, stainless steel, aluminum alloys, or the like. In some cases, the protective enclosure 200 may be constructed from A36 steel. The use of A36 steel may provide durability and strength to the protective enclosure 200. The metal may be treated or untreated, depending on the desired level of security and resistance to tampering. Treatment of the metal may enhance its resistance to drilling, cutting, or other forms of forced entry. Such treatments may include case hardening, which creates a hardened outer layer while maintaining a ductile core, or the application of specialized coatings such as powder coating or galvanization to provide corrosion resistance in outdoor or harsh industrial environments. Additionally or alternatively, the metal may be heat-treated to further resistance to cutting and drilling.

Referring to FIG. 3B, a front view of the protective enclosure 200 is shown. The pipe openings 202 are aligned along the length of the protective enclosure 200 when viewed from the front. This view more clearly illustrates the relationship between the first portion 204 and the second portion 206, showing how they fit together to form the protective enclosure 200. The lock guards 210 are visible on the top surface of the second portion 206, positioned to protect underlying locking mechanisms.

Referring to FIG. 3C, a side view of the protective enclosure 200 is shown. The lock guards 210 are visible on the top surface of the second portion 206, positioned at opposite ends along the lengthwise direction of the protective enclosure 200, to protect the underlying locking mechanisms. In the illustrated embodiment, the lock guards 210 are laterally coterminous with the ends of the protective enclosure 200. In other embodiments, the lock guards 210 may be disposed some distance from the ends of the protective enclosure 200.

Referring to FIG. 3D, a top-down view of the protective enclosure 200 is shown.

This view illustrates the second portion 206 when viewed from above, showing the arrangement of components on the top surface of the second portion 206. The protective enclosure 200 has a rectangular shape when viewed from this perspective, with the lock guards 210 positioned near opposite ends of the second portion 206.

The apertures 218 (shown in ghost) may be aligned with the center of the second portion 206 along the lengthwise direction of the protective enclosure 200 (e.g., the same direction as a pipe the protective enclosure 200 will be fitted on). These apertures 218 may be rectangular openings, positioned beneath the lock guards 210, and are designed to allow locking tabs of clamping assemblies to extend through the second portion 206.

The lock guards 210 may be positioned offset from the center of the second portion 206 along the lengthwise direction of the protective enclosure 200. This offset positioning creates additional spaces in the areas where locking mechanisms may be installed to lock the protective enclosure 200. The aperture 218 beneath a lock guard 210 is positioned closer to one side of the lock guard 210 than the other side of the lock guard 210, creating an asymmetrical arrangement that provides sufficient space in the lock guards 210 for the locking mechanisms to be installed and operated. Specifically, this arrangement allows easier access to install locking mechanisms through locking tabs (of clamping assemblies) that extend through the apertures 218 when the protective enclosure 200 is assembled.

In the illustrated embodiment, the apertures 218 are straight, extending in a direction that form a right angle with the sidewalls of the second portion 206. In other embodiments (subsequently described), the apertures 218 may be diagonal, extending in a direction that forms an oblique angle (i.e., non-right angle) with the sidewalls of the second portion 206. The orientation of the apertures 218 may affect the positioning and accessibility of the subsequently installed locking mechanisms. In some cases, the diagonal arrangement can provide additional clearance for inserting and removing the locking mechanisms.

Referring to FIG. 3E, a cross-sectional view of the protective enclosure 200 is shown along reference cross-section E-E in FIGS. 3C and 3D. A pipe opening 202 and an aperture 218 are shown in ghost for reference. Furthermore, two seams 238 (where the first portion 204 and the second portion 206 meet) are shown in ghost for reference. The seams 238 are on either side of the pipe opening 202, and are connected to the pipe opening 202. While not separately illustrated in FIG. 3E, it should be appreciated that each seam 238 connects the pipe openings 202 at the opposing ends of the protective enclosure 200.

In the cross-sectional view, the external lips 208 cover the seams 238 of the first portion 204 and the second portion 206. Thus, the external lips 208 overlap sidewalls 234 of the first portion 204 and also overlap sidewalls 236 of the second portion 206. The external lips 208 may be permanently attached to either the sidewalls 234 of the first portion 204 or to the sidewalls 236 of the second portion 206, but in either implementation, the external lips 208 overlap the seams 238 and the sidewalls 234, 236 of both portions when the protective enclosure 200 is assembled. This overlapping arrangement prevents insertion of prying tools into the seams 238 between the first portion 204 and the second portion 206.

In some implementations, the external lips 208 may cover a greater portion of one sidewall than the other sidewall. Specifically, the external lips 208 may extend up the sidewalls 236 of the second portion 206 further than they extend down the sidewalls 234 of the first portion 204, or vice versa. This asymmetrical coverage may be particularly pronounced when the external lips 208 are permanently affixed to one of the portions. In cases where the external lips 208 are attached to the second portion 206, they may extend further up the sidewalls 236 of the second portion 206. In cases where the external lips 208 are attached to the first portion 204, they may extend further down the sidewalls 234 of the first portion 204. In other implementations, the external lips 208 may cover the same amount of both sidewalls.

The arrangement of the apertures 218, in conjunction with the lock guards 210 and the external lips 208, may contribute to the overall security of the protective enclosure 200. It may allow for secure locking of the first portion 204 to the second portion 206 while maintaining accessibility for authorized personnel to operate the locking mechanisms used to secure the protective enclosure 200.

The protective enclosure 200 may have specific dimensions to accommodate various valve sizes and pipe configurations. The dimensions of different components of the protective enclosure 200 will be detailed with reference to all of FIGS. 3A-3E.

The overall dimensions of the protective enclosure 200 are designed to provide ample space for enclosing valves while maintaining a compact profile. In some embodiments, the protective enclosure 200 may have a width W1 (see FIG. 3B) of about 8 inches and a length L1 (see FIG. 3C) of about 13 inches. In some embodiments, the first portion 204 and the second portion 206 may have a combined height H1 (see FIG. 3B) of about 12.5 inches.

These dimensions may allow the protective enclosure 200 to accommodate a range of commonly used valves.

The first portion 204 and the second portion 206 of the protective enclosure 200 may have different heights. In some embodiments, the first portion 204 may have a height H2 of about 4 inches (see FIG. 3E). In some embodiments, the second portion 206 may have a height H3 of about 8.5 inches (see FIG. 3E). The height H2 of the first portion 204 may be less than the height H3 of the second portion 206. This height difference may allow for efficient use of space within the protective enclosure 200.

The external lips 208 play an important role in securing the protective enclosure 200. In some embodiments, the external lips 208 may have a height H4 (see FIG. 3B) of about 1.5 inches. In some embodiments, the external lips 208 may overlap the sidewalls 234 of the first portion 204 by a distance D1 (see FIG. 3E) of about 0.75 inches. In some embodiments, the external lips 208 may overlap the sidewalls 236 of the second portion 206 by a distance D2 (see FIG. 3E) of about 0.75 inch. In this example, the distance D1 is equal to the distance D2. The distance D1 may be less than the distance D2. This configuration may ensure a secure fit between the first and second portions of the protective enclosure 200.

The pipe openings 202 are sized to accommodate standard pipe diameters while maintaining the security of the enclosed valve. In some embodiments, the pipe openings 202 may have a diameter D3 (see FIG. 3B) of about 2 inches, about 3 inches, about 3.6 inches, about 4 inches, about 4.5 inches, or about 5 inches. These dimensions allow the protective enclosure 200 to be installed on a variety of pipe sizes commonly used in industrial applications.

The lock guards 210 are designed to protect the locking mechanisms of the protective enclosure 200. In some embodiments, the lock guards 210 may have a height H5 of about 2.5 inches (see FIG. 3E), with the interior openings for the locking mechanisms having a height of about 2.25 inches. In some embodiments, the lock guards 210 may have a width W2 (see FIG. 3D) of about 4.5 inches and a length L2 (see FIG. 3D) of about 4.5 inches. The width W2 may be equal to the length L2. In some embodiments, a lock guard may be disposed a distance D4 (see FIG. 3D) from a first side of the second portion 206 of about 2.25 inches. In some embodiments, a lock guard 210 may be disposed a distance D5 (see FIG. 3D) from an opposing second side of the second portion 206 of about 1.25 inches. The distance D5 may be less than the distance D4, particularly when the lock guards 210 are offset. These dimensions and positioning of the lock guards 210 may provide good protection for the locking mechanisms.

The apertures 218 in the second portion 206 are sized and positioned to accommodate locking tabs while maintaining the enclosure's integrity. In some embodiments, the apertures 218 may have a width W3 (see FIG. 3D) of about 0.38 inches and a length L3 (see FIG. 3D) of about 1.75 inches. The width W3 may be less than the length L3. In some embodiments, an aperture 218 may be disposed a distance D6 (see FIG. 3D) from a closest end of the second portion 206 of about 1 inch. These dimensions may ensure that the apertures 218 are appropriately sized and positioned for accommodating locking tabs.

While the dimensions provided above are representative of some embodiments, other dimensions may be utilized depending on the specific application and valve and/or pipe size requirements. For example, some of the dimensions provided above may be utilized for a 3 inch pipe, while other dimensions may be utilized for a 2 inch or 4 inch pipe. The flexibility in dimensions allows the protective enclosure 200 to be adapted to various industrial settings and valve configurations while maintaining its protective capabilities.

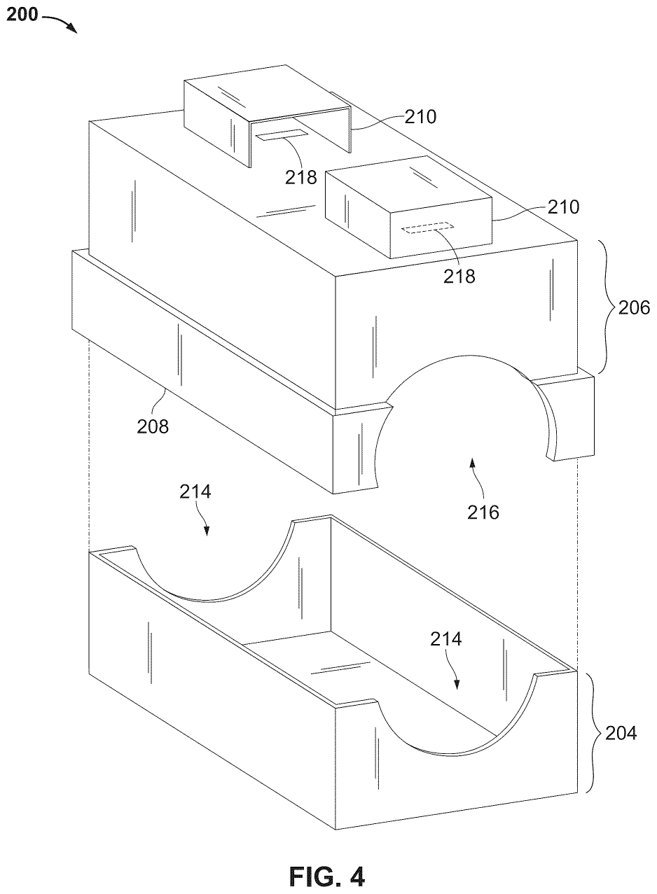

FIG. 4 illustrates an exploded isometric view of the protective enclosure 200, according to some embodiments. Specifically, the separation between the first portion 204 and the second portion 206 is shown.

The first portion 204 and the second portion 206 are arranged to mate together, with the external lips 208 providing an overlap between the two portions. When assembled, the lock guards 210 and underlying locking mechanisms may work in conjunction to secure the first portion 204 to the second portion 206, preventing unauthorized access to a valve contained within the protective enclosure 200.

The first portion 204 may include first semicircular openings 214 positioned on opposite ends, while the second portion 206 may include second semicircular openings 216 positioned on opposite ends, which together may allow the protective enclosure 200 to accommodate a pipe passing through the assembly. The first semicircular openings 214 and the second semicircular openings 216 may be shaped to conform to the desired diameter of a pipe and provide access points for the protective enclosure 200 to be mounted around the pipe. For example, the first semicircular openings 214 and the second semicircular openings 216 may be half-moon shaped openings.

The first semicircular openings 214 of the first portion 204 align with the second semicircular openings 216 of the second portion 206 when assembled. When the first portion 204 and the second portion 206 are assembled, the first semicircular openings 214 and the second semicircular openings 216 may merge to complete the pipe openings 202 (see FIGS. 3A-3E) for accommodating a pipe passing through the protective enclosure 200. That is, the pipe openings 202 are formed when the first semicircular openings 214 are aligned with the second semicircular openings 216. This alignment of the first semicircular openings 214 and the second semicircular openings 216 may ensure a secure fit around the pipe while maintaining the protective function of the protective enclosure 200.

FIG. 5 illustrates clamping assemblies 250 for the protective enclosure 200, according to some embodiments. Each clamping assembly 250 includes a first clamp 220, a second clamp 224, and a locking tab 226. One clamping assembly 250 will be installed at each end of the protective enclosure. This may provide secure attachment points for the clamping assemblies 250 within the protective enclosure.

Fasteners, such as mounting nuts 222, may be affixed to each first clamp 220. The mounting nuts 222 may serve as connection points between the first clamps 220 and the second clamps 224, allowing for secure assembly of the clamping assemblies 250. Bolts 230 may be used to secure the second clamps 224 to the first clamps 220 through the mounting nuts 222.

This arrangement may be reversed; that is, the bolts 230 may be affixed to the first clamps 220 and the mounting nuts 222 may then be used to secure the second clamps 224 to the first clamps 220 through bolts 230.

Each second clamp 224 may be designed to mate with its corresponding first clamp 220, with both components having curved surfaces that may form a circular opening when assembled together. Specifically, the first clamps 220 and the second clamps 224 are semicircular. When assembled, each pair of a first clamp 220 and a second clamp 224 may form a circular structure (e.g., ring) that encircles a pipe passing through the protective enclosure.

Each second clamp 224 may include a locking tab 226 that extends upward from its surface. These locking tabs 226 may extend through corresponding apertures in the second portion of the protective enclosure when assembled. In the illustrated embodiment, the locking tabs 226 are straight. In other embodiments (subsequently described), the locking tabs 226 may be bent such that they have a horizontal offset.

Each locking tab 226 may include a lock opening 228 positioned near its end which is distal from the second clamp 224. Each lock opening 228 may be aligned beneath a corresponding lock guard when the protective enclosure is assembled. This alignment may allow for a locking mechanism to be secured through each lock opening 228 of the clamping assemblies 250. For example, when the locking mechanisms are padlocks, the shackles of the padlocks may be inserted into the lock openings 228.

The design of the clamping assemblies 250 may allow for easy installation and removal by authorized personnel while maintaining a secure grip on a pipe. The combination of the first clamps 220, the second clamps 224, the mounting nuts 222, and the bolts 230 may provide a robust clamping mechanism that resists tampering and unauthorized removal of the protective enclosure from a pipe.

The first clamps 220, second clamps 224, mounting nuts 222, and bolts 230 may each be formed of steel or another durable metal capable of withstanding tampering attempts. The material for the clamping components may be selected based on factors such as strength, durability, and resistance to tampering. In some cases, the clamping components may be constructed from the same material as the protective enclosure 200.

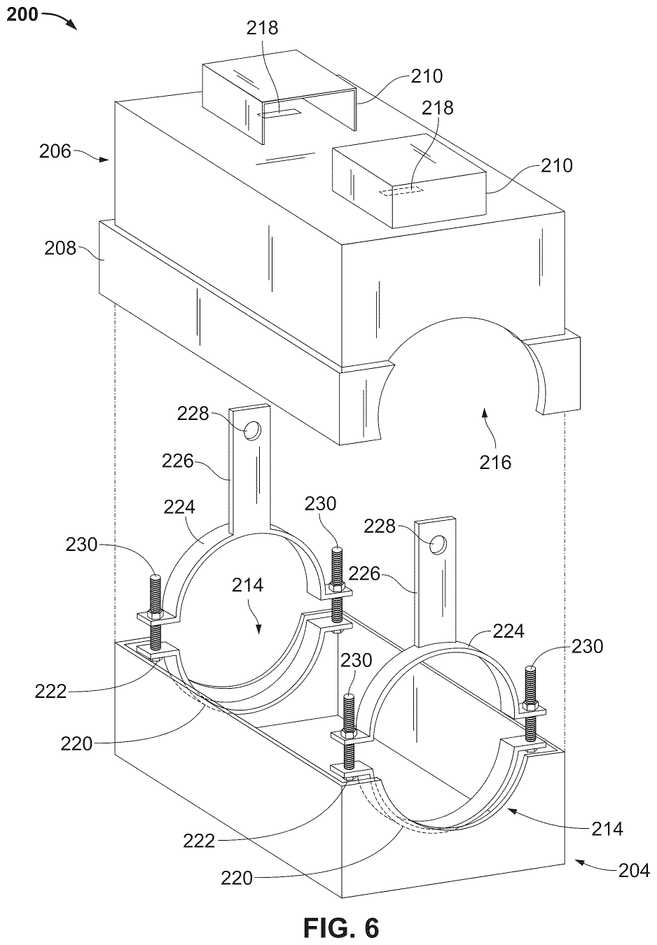

FIG. 6 illustrates an exploded isometric view of the protective enclosure 200, according to some embodiments. Additional components of the protective enclosure 200, and specifically, the clamping assemblies 250 are shown. The clamping assemblies 250 are shown in relation to the first portion 204 and the second portion 206 of the protective enclosure 200, demonstrating how these components fit together to secure a valve on a pipe.

The first clamps 220 are installed in the first portion 204, around the first semicircular openings 214. When assembled, a first clamp 220 and a second clamp 224 may work together to encircle and secure a pipe passing through their curved openings. The corresponding locking tabs 226 of the second clamps 224 may extend through the apertures 218 in the second portion 206 of the protective enclosure 200, positioning the lock openings 228 beneath the lock guards 210 where locking mechanisms (e.g., bolt shackles) may be inserted.

This alignment may allow for a locking mechanism to be secured through each lock opening 228, thus preventing the locking tabs 226 from being removed from the apertures 218 and effectively locking the first portion 204 to the second portion 206.

The clamping assemblies 250 with multiple securing points may work in conjunction with the external lips 208 and the lock guards 210 to provide multiple layers of security for the protective enclosure 200. By securing the protective enclosure 200 directly to a pipe at multiple locations and incorporating locking mechanisms that are protected by the structure of the protective enclosure 200 itself, the internal clamping assemblies 250 may significantly enhance the overall security of the valve contained within the protective enclosure 200.

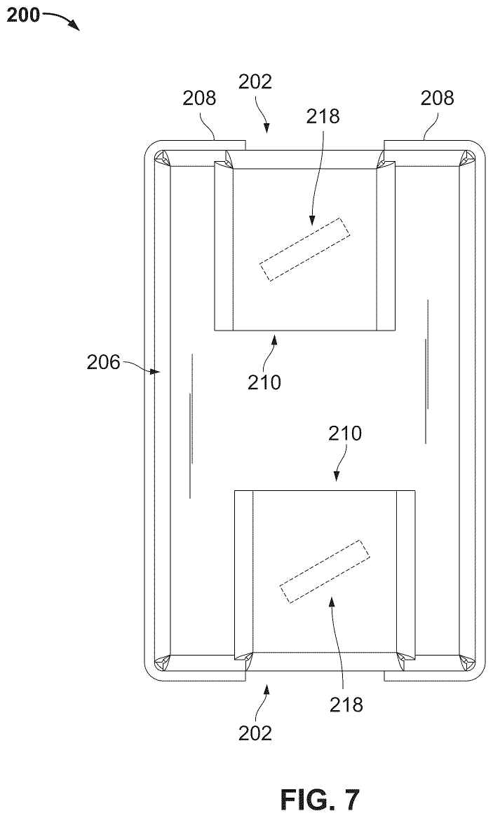

FIG. 7 illustrates a cross-sectional view of a protective enclosure 200, according to some other embodiments. A similar view as FIG. 3E is shown. This embodiment is similar to the embodiment of FIG. 3E, except the apertures 218 are diagonal, extending in a direction that forms an oblique angle (i.e., non-right angle) with the sidewalls of the second portion 206. When the lock guards 210 are offset, each aperture 218 is angled such that the end of the aperture 218 closest to the sidewall of its corresponding lock guard 210 is angled towards the corresponding end of the protective enclosure 200.

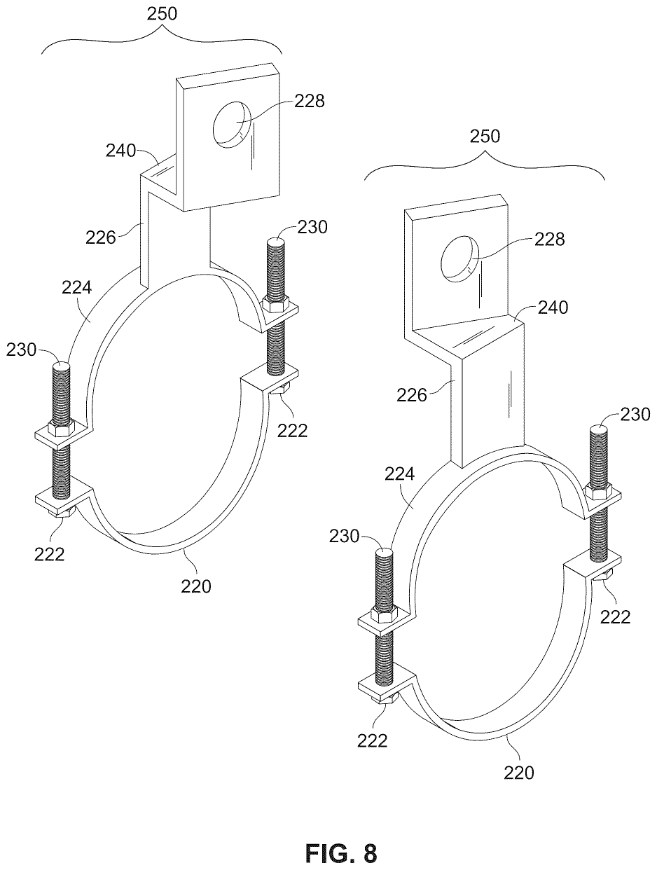

FIG. 8 illustrates clamping assemblies 250 for the protective enclosure 200, according to some other embodiments. This embodiment is similar to the embodiment of FIG. 5, except the locking tabs 226 are bent such that they have a horizontal offset. Specifically, each locking tab 226 includes a first vertical portion extending upwards from a second clamp 224, a second vertical portion with a lock opening 228, and a horizontal portion 240 extending perpendicular to and between the vertical portions.

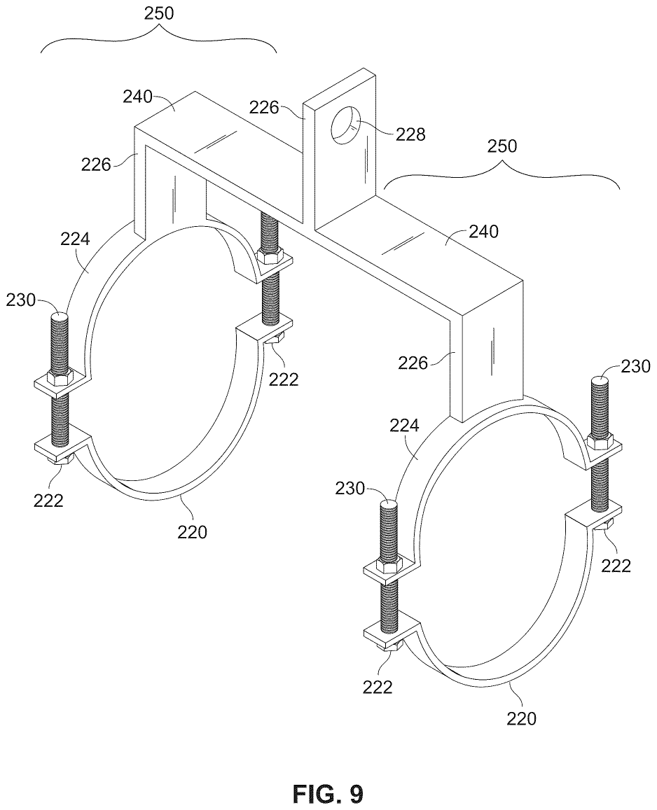

FIG. 9 illustrates clamping assemblies 250 for the protective enclosure 200, according to some other embodiments. This embodiment is similar to the embodiment of FIG. 8, except a locking tab 226 is shared among the second clamps 224. Specifically, the locking tab 226 has multiple first vertical portions extending upwards from the second clamps 224, a horizontal portion 240 extending perpendicular to and between those first vertical portions, and a second vertical portion with a lock opening 228 extending upwards from the horizontal portion 240. This arrangement may also be utilized in enclosures for smaller pipes. When this type of the clamping assemblies 250 is utilized, the protective enclosure may have only one lock guard, such as a lock guard positioned in the center of the enclosure's top surface. Other variations of this embodiment are contemplated. In some cases, the horizontal portion 240 may be removeable. For example, vertical portions of the locking tab 226 may extend upwards from the second clamps 224; the horizontal portion 240 and the vertical portion with the lock opening 228 may be part of an assembly (e.g., a bar with attached tab) that is detachably coupled to the vertical portions of the locking tab 226.

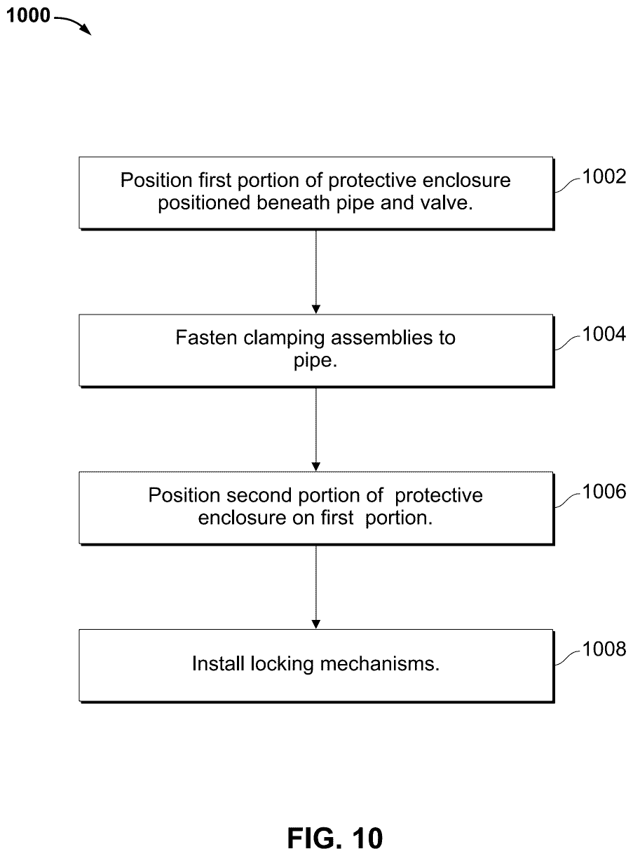

FIG. 10 illustrates a flowchart of a method 1000 for installing the protective enclosure 200, according to some embodiments. The method 1000 will be described in conjunction with FIGS. 3A-9. The method 1000 may be performed by a technician when securing a valve that is affixed to a pipe. The installation process is designed to be straightforward yet secure, allowing authorized personnel to efficiently protect vulnerable valves in industrial or remote settings.

In step 1002, the first portion 204 of the protective enclosure 200 is positioned beneath the pipe and valve. The first semicircular openings 214 are aligned with the pipe. The first clamps 220, which are attached to the first portion 204, may cradle the pipe.

In step 1004, the clamping assemblies 250 are fastened to the pipe. Specifically, the second clamps 224 are attached to the first clamps 220. The second clamps 224 are placed over the pipe and aligned with the first clamps 220. When the mounting nuts 222 are affixed to the first clamps 220, the bolts 230 may be inserted through the second clamps 224 and tightened into the mounting nuts 222, securing the clamping assemblies 250 to the pipe.

In step 1006, the second portion 206 may be aligned with and then placed onto the first portion 204. This includes engaging the external lips 208 over the seams 238 between the first portion 204 and the second portion 206, such as by a sliding or overlapping motion. As the second portion 206 is lowered onto the first portion 204, the external lips 208 may be guided to overlap the sidewalls of both portions. The external lips 208 may have a slightly larger internal dimension than the outer dimensions of the first portion 204 and the second portion 206, allowing them to slide over and encompass the respective portion. As a result, once assembled, the external lips 208 overlap the first portion 204 and the second portion 206. The second semicircular openings 216 of the second portion 206 are also aligned with the first semicircular openings 214 of the first portion 204. The locking tabs 226 of the second clamps 224 may be inserted through the apertures 218 in the second portion 206 until the lock openings 228 are exposed within the lock guards 210. That is, the lock openings 228 are outside of the second portion 206.

In step 1008, locking mechanisms may be installed, completing the enclosure installation and securing the valve within the protective enclosure 200. The locking mechanisms may be inserted through the lock openings 228 beneath the lock guards 210. The lock guards 210 provide protection for the locking mechanisms, which are positioned underneath the lock guards 210 to prevent tampering with the locking mechanisms.

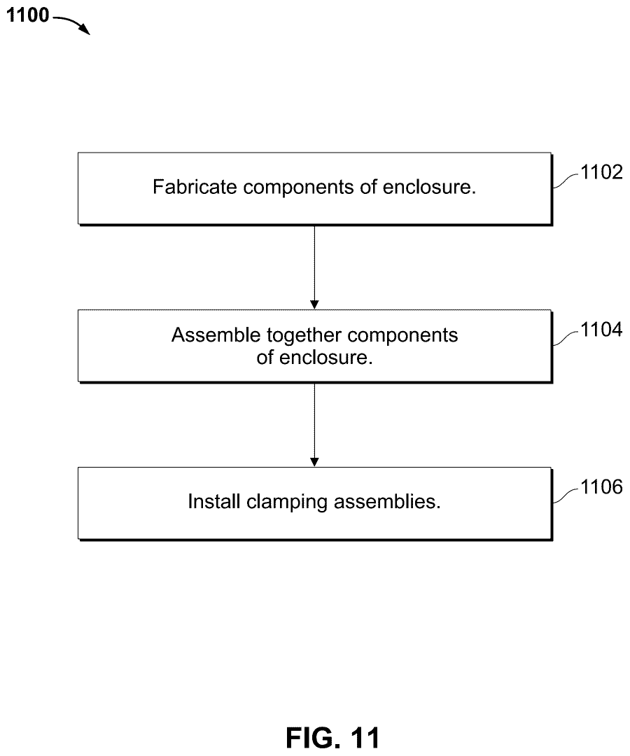

FIG. 11 illustrates a flowchart of a method 1100 for manufacturing the protective enclosure 200, according to some embodiments. The method 1100 will be described in conjunction with FIGS. 3A-9.

In step 1102, the individual components of the protective enclosure 200 are fabricated. Each component of the protective enclosure 200 (including the first portion 204, the second portion 206, the external lips 208, and the lock guards 210) may be formed from a single continuous layer or sheet of metal. The manufacturing process may involve precision metal fabrication techniques. In some cases, the enclosure components may be manufactured by first stamping or cutting flat metal sheets into specific patterns or templates using, e.g., industrial presses, laser cutting equipment, or the like. These flat patterns are then bent into the three-dimensional shapes for each component using, e.g., metal brakes or the like. After bending a component into its shape, the metal edges are aligned and permanently joined, e.g., through welding processes. Each enclosure component may be formed from a single metal sheet that is stamped into a specific shape (e.g., T-shape or cross-shape) and then bent along predetermined fold lines to form the desired structure. Once bent into the final shape, the adjoining edges and corners are then welded together to create seamless joints using, e.g., continuous welding techniques. The welded seams of the protective enclosure 200 may be reinforced through complete penetration welds to prevent separation even when subjected to significant force or tampering attempts. Continuous welds, rather than spot welds, may be implemented at all joints to avoid potential weak points that could otherwise be exploited.

The components of the protective enclosure 200 may have any desired thickness. Furthermore, some components may have different thicknesses. In some embodiments, the first portion 204, the second portion 206, the external lips 208, and the lock guards 210 may all have the same thickness. In some embodiments, the first portion 204 and the second portion 206 may have a first thickness, while the external lips 208 and the lock guards 210 may have a second thickness that is different from the first thickness. The second thickness may be less than or greater than the first thickness. In some embodiments, the metal sheets used to form the first portion 204 and the second portion 206 are thicker than the metal sheets used to form the external lips 208 and the lock guards 210. The thicknesses of the components of the protective enclosure 200 may be determined by the thicknesses of the metal sheets from which the components are formed. In some embodiments, the first portion 204 and the second portion 206 are formed from 3/16 inch thick A36 steel while the external lips 208 and the lock guards 210 are formed from ¼ inch thick A36 steel.

In step 1104, the fabricated components are assembled together to form the protective enclosure 200. The components may be assembled by any suitable process, such as through welding techniques. The external lips 208 may be welded to the second portion 206 or the first portion 204, creating a permanent attachment that prevents separation even under significant force. In some embodiments, the external lips 208 may be welded to the sidewalls 236 of the second portion 206. In some embodiments, the external lips 208 may be welded to the sidewalls 234 of the first portion 204. The lock guards 210 may be welded to the second portion 206. In some embodiments, the lock guards 210 may be welded to the top surface of the second portion 206.

In step 1106, the clamping assemblies 250 are installed in the assembled components. The clamping assemblies 250 (e.g., the first clamps 220) may be welded to the first portion 204. Each first clamp 220 may be welded to the inside of an end of the first portion 204, around a corresponding first semicircular opening 214.

The protective enclosure 200 incorporates several features that enhance security and prevent unauthorized access to valves. The external lips 208 overlapping the first portion 204 and the second portion 206 effectively block the insertion of prying tools into the protective enclosure 200. The second portion 206 also includes strategically positioned lock guards 210 and apertures 218, which work in conjunction with the clamping assemblies 250 to provide multiple layers of security. This design may offer advantages such as improved tamper resistance, ease of installation and removal for authorized personnel, and adaptability to various pipe sizes. The modular construction of the first portion 204 and the second portion 206, along with the internal clamping assemblies 250, may allow for efficient manufacturing and assembly while maintaining structural integrity and security. These features may collectively contribute to a robust and versatile solution for protecting valves in various industrial applications.

The protective enclosure described herein has broad industrial applicability across various sectors where securing valves and preventing unauthorized access is important. The embodiments may be particularly useful in industries such as oil and gas, water treatment, chemical processing, and manufacturing. The protective enclosure can be applied to secure valves in pipelines, storage facilities, and distribution networks, enhancing safety and preventing product loss. Its robust design and adaptability to different pipe sizes make it suitable for both indoor and outdoor industrial environments. The ease of installation and removal for authorized personnel, coupled with its tamper-resistant features, may improve operational efficiency while maintaining high security standards in industrial fluid systems.

While the embodiments have been described with reference to illustrative embodiments, this description is not intended to be construed in a limiting sense. Various modifications and combinations of the illustrative embodiments, as well as other embodiments, will be apparent to persons skilled in the art upon reference to the description. It is therefore intended that the appended claims encompass any such modifications or embodiments.

1. A protective enclosure comprising:
a first open box structure having a first semicircular opening at an end of the first open box structure;
a second open box structure having a second semicircular opening and an aperture, the second semicircular opening disposed at an end of the second open box structure, the aperture disposed on a top surface of the second open box structure;
a lock guard on the top surface of the second open box structure, the lock guard disposed over the aperture;
an external lip positioned to cover a seam between the first open box structure and the second open box structure when the first open box structure and the second open box structure are joined together; and
a clamping assembly comprising a first clamp and a second clamp, the first clamp welded to an inside of the end of the first open box structure and extending around the first semicircular opening, the second clamp comprising a curve and a locking tab that is integral with the curve, wherein the curve of the second clamp extends around the second semicircular opening when the first clamp and the second clamp are fastened together, wherein the locking tab has a lock opening, wherein the locking tab extends through the aperture such that the lock opening is positioned above the top surface of the second open box structure when the first open box structure and the second open box structure are joined together.

2. The protective enclosure of claim 1, wherein the seam is connected to a pipe opening formed by the first semicircular opening merging with the second semicircular opening when the first open box structure and the second open box structure are joined together.

3. The protective enclosure of claim 1, wherein the external lip is affixed to a sidewall of the second open box structure and overlaps a sidewall of the first open box structure when the first open box structure and the second open box structure are joined together.

4. The protective enclosure of claim 3, wherein the external lip extends up the sidewall of the second open box structure further than the external lip extends down the sidewall of the first open box structure.

5. The protective enclosure of claim 1, wherein the external lip is affixed to a sidewall of the first open box structure and overlaps a sidewall of the second open box structure when the first open box structure and the second open box structure are joined together.

6. The protective enclosure of claim 5, wherein the external lip extends down the sidewall of the first open box structure further than the external lip extends up the sidewall of the second open box structure.

7. The protective enclosure of claim 1, wherein the lock guard is offset from a center of the second open box structure.

8. The protective enclosure of claim 7, wherein the aperture is aligned with the center of the second open box structure.

9. The protective enclosure of claim 1, wherein the aperture extends in a direction that forms a right angle with a sidewall of the second open box structure.

10. The protective enclosure of claim 1, wherein the aperture extends in a direction that forms an oblique angle with a sidewall of the second open box structure.

11. The protective enclosure of claim 1, wherein a thickness of the external lip is different than a thickness of the first open box structure and the second open box structure.

12. The protective enclosure of claim 1, wherein the clamping assembly further comprises mounting nuts affixed to the first clamp.

13. (canceled)

14. A method comprising:
fabricating a first open box structure from a first metal sheet, the first open box structure having a first semicircular opening at an end of the first open box structure;
fabricating a second open box structure from a second metal sheet, the second open box structure having a second semicircular opening at an end of the second open box structure, the second open box structure also having an aperture in a top surface of the second open box structure;
fabricating an external lip from a third metal sheet;
welding the external lip to a sidewall of the second open box structure, the external lip positioned to cover a seam between the first open box structure and the second open box structure when the first open box structure and the second open box structure are joined together;
fabricating a clamping assembly comprising a first clamp and a second clamp, the second clamp comprising a curve and a locking tab that is integral with the curve, the locking tab having a lock opening; and
welding the first clamp to an inside of the end of the first open box structure, the first clamp extending around the first semicircular opening, wherein the locking tab extends through the aperture such that the lock opening is positioned above the top surface of the second open box structure when the first open box structure and the second open box structure are joined together.

15. The method of claim 14, wherein the external lip covers a greater portion of the sidewall of the second open box structure than a sidewall of the first open box structure.

16. The method of claim 14, wherein the first metal sheet and the second metal sheet are thicker than the third metal sheet.

17. The method of claim 14, wherein the first metal sheet, the second metal sheet, and the third metal sheet are each formed of A36 steel.

18. (canceled)

19. The method of claim 14, further comprising:
welding a lock guard to the top surface of the second open box structure and over the aperture.

20. A method comprising:
positioning a first open box structure beneath a pipe and a valve, the first open box structure having a first semicircular opening at an end of the first open box structure, the first semicircular opening being aligned with the pipe;
securing the first open box structure to the pipe by fastening a clamping assembly to the pipe, wherein the clamping assembly comprises a first clamp and a second clamp, the second clamp comprising a curve and a locking tab that is integral with the curve, the locking tab having a lock opening, wherein the first clamp is welded to an inside of the end of the first open box structure and extends around the first semicircular opening, wherein the second clamp is fastened to the first clamp, wherein the first clamp and the second clamp encircle the pipe when fastened together;
positioning a second open box structure over the first open box structure, the second open box structure having a second semicircular opening at an end of the second open box structure, the second semicircular opening being aligned with the pipe, the curve of the second clamp extending around the second semicircular opening;
engaging an external lip over a seam between the first open box structure and the second open box structure;
inserting the locking tab of the clamping assembly through an aperture in the second open box structure, the lock opening being positioned above the second open box structure when the locking tab extends through the aperture; and
installing a locking mechanism through the lock opening in the locking tab.

21. (canceled)

22. The method of claim 20, wherein the locking mechanism comprises a padlock and installing the locking mechanism comprises inserting a shackle of the padlock through the lock opening in the locking tab.

23. The method of claim 20, wherein the locking mechanism is installed under a lock guard that is attached to the second open box structure, wherein the lock guard covers the locking mechanism, the aperture, and the locking tab of the clamping assembly.

24. The method of claim 20, wherein the first open box structure and the second open box structure form a box-shaped structure that completely surrounds the valve on six sides.

25. The method of claim 20, wherein the external lip covers a greater portion of a sidewall of the second open box structure than a sidewall of the first open box structure, wherein the external lip is affixed to the sidewall of the second open box structure while remaining detached from the sidewall of the first open box structure.

26. The method of claim 20, wherein fastening the clamping assembly to the pipe comprises inserting a bolt through the second clamp and tightening the bolt into a mounting nut that is affixed to the first clamp.

27. The method of claim 20, wherein the locking tab extends straight upward from the curve of the second clamp.

28. The protective enclosure of claim 1, wherein the lock guard extends above the top surface of the second open box structure to cover the aperture.
